(19) United States
(12) Patent Application Publication
(10) Pub. No.: US 2009/0307986 A1
(43) Pub. Date: Dec. 17, 2009

(54) Polishing composition and making method thereof for polishing a substrate

(76) Inventor: Hung-Hui Huang, Pingjhen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,954

(22) Filed: Jun. 12, 2008

(51) Int. Cl. C08J 5/14

(52) U.S. Cl. 51/298

(57) ABSTRACT

A polishing composition and making method thereof is provided, in which a plurality of abrasive particles, organic resins, and an initiator are mixed and stirred into slurry. These abrasive particles are dispersed uniformly in the slurry. Then, the slurry is poured into a mold with a predefined shape. The slurry is formed into the polishing composition in the corresponding predefined shape. Thus, the polishing composition contains higher concentration of abrasive particles which can quickly polish a substrate, and the surface of the substrate will not easily be scratched from the polishing composition.

### BACKGROUND OF THE INVENTION

1. Field of the Invention

The present invention relates to a polishing composition and making method thereof and particularly to a polishing composition and making method thereof in which a substrate may be quickly polished and no scratches is formed on the surface of the substrate.

2. Description of Related Art

In a conventional polishing method, a mechanical power drives slurry containing water and a plurality of abrasive particles 10a to polish the surface 101a of a substrate 100a. Slurry here is a specific technical term which refers to an abrasive substance used in chemical-mechanical polishing, usually in a semiconductor manufacturing process. With reference to FIG. 1, the abrasive particles 10a may be in a ball-like shape (FIG. 1) or a slab-like shape (not shown). A tip of the abrasive particle 10a is capable of cutting the substrate 100a, and the larger the abrasive particle 10a is, the more apparent the cutting capability of the particle 10a.

The slurry applies pressure against the substrate 100a along the direction indicated by the arrow in FIG. 1, and the abrasive particles 10a in the slurry (slurry not shown) are used to roll on the surface 101a of substrate 100a so that the substrate 100a may be cut for achievement of the polishing process.

However, there are some problems when the polishing is implemented in the conventional technology, as shown below.
1. The rigidity of abrasive particles is limited to the hardness of the substrate that it is being applied to, and the abrasive particles should only be slightly higher than that of the substrate but cannot be higher by too much, otherwise the surface of the substrate is easily scratched.
2. When the abrasive particles that are mixed in the slurry has different sizes, the abrasive particles with bigger size will more easily scratch the surface of the substrate; thus, before implementation, the abrasive particles must be sieved for uniform particle size and then only abrasive particles of uniform size may be used.
3. The amount of abrasive particles in the slurry generally does not make up more than 30% of total weight, so the area that comes into contact with abrasive particles capable of polishing the substrate is in fact very small; thus a long-time for polishing is required for achieving the required flat, smooth surface.
4. During polishing, the outer fringe of the abrasive particle works to cut the surface of the substrate in the form of point cutting, which only utilizes a small area of cutting surface of the abrasive particle, thus the polishing (i.e. cutting) efficiency of the abrasive particle is low, and large quantity of water and large amount of abrasive particles must be continuously supplemented in the process in order to achieve the required flat surface, which easily wastes water and the abrasive particles and pollutes the environment when the waste slurry is discharged.

Consequently, because of the technical problems and limitations of the described above, the applicant strives via real world experience and academic research to develop the present invention, which can effectively improve the problems and limitations described above.

### SUMMARY OF THE INVENTION

The present invention is mainly to provide a polishing composition for polishing a substrate, wherein the polishing composition includes an organic resin bonding with a plurality of abrasive particles and contains higher concentration of abrasive particles. When a substrate is polished, the area where the abrasive particles contact the substrate is larger so that the time for polishing may be significantly shortened and scratches will not easily occur.

The present invention further provides a method of making the polishing composition for polishing a substrate, in which the organic resin, the plurality of abrasive particles, and an initiator are mixed into the polishing composition so that the abrasive particles may be closely and evenly disperse in the polishing composition and the polishing composition may be formed in a constant (i.e. defined) shape for polishing the substrate.

In order to achieve the objects mentioned above, the polishing composition in the defined shape is provided in the present invention and comprises at least a single type of the plurality of abrasive particles (i.e. single type particle representing a single type of abrasive particle; or mixed particles representing multiple types of abrasive particles), at least a single type of organic resin (i.e. single type resin representing a single type of organic resin; or mixed resins representing multiple types of resins) bonding with the abrasive particles into integral whole, and an initiator. The abrasive particles evenly disperse in the integral polishing composition, wherein the abrasive particles are made from one of ceric oxide, aluminum oxide, diamond, silicon carbide, zirconia, silicon dioxide, barium carbonate, titanium oxide, and silicon. The organic resin is made from one of acrylic resin, polyketone resin, unsaturated mylar (a.k.a. unsaturated polyester resin), organosilicon resin, and epoxy resin.

The method of making the polishing composition for polishing a substrate according to the present invention comprises steps of: mixing and stirring at least a single type of the plurality of abrasive particles, the liquid organic resin, and the initiator into the slurry, in which the abrasive particles are made from one of ceric oxide, aluminum oxide, diamond, silicon carbide, zirconia, silicon dioxide, barium carbonate, titanium oxide, and silicon and the organic resin is made from one of acrylic resin, polyketone resin, unsaturated mylar, organosilicon resin, and epoxy resin; homogenizing the slurry so as to make the abrasive particles evenly disperse in the slurry; filling the slurry in a mold with a predefined shape; and forming the slurry into the polishing composition in the corresponding predefined shape.

The present invention brings advantages as follows. In the present invention, via adjusting the types of abrasive particles and organic resin, or via adjusting the size of abrasive particles, then the property of polishing composition can be adjusted for application to various substrates. In the present invention, various abrasive particles may be combined with each other to enhance their capability of cutting and prevent scratches from occurring. In the present invention, there is no strict limit to the size of abrasive particles, and the abrasive particles may be effectively used to prevent the abrasive particles from being wasted, thereby significantly shortens the time of polishing, increases the yield, and prevents the environment from being polluted.

In order to further understand the technical means and effects adopted to achieve the objectives of the present invention, please refer to the detailed description and accompanied drawings according to the present invention. It is believed that the objectives, features, and points of the present invention will be apparent from the description; however, the accompanied drawings are provided for reference and illustration only and are not intended to limit the terms or scope of the present invention.

### BRIEF DESCRIPTION OF THE DRAWINGS

FIG. 1 is a schematic view illustrating a polishing process in a conventional technology;

FIG. 2 is a front view of a polishing composition in a first embodiment of the present invention;

FIG. 3 is a top view of the polishing composition in the first embodiment of the present invention;

FIG. 4 is 3D schematic view illustrating the polishing composition in a second embodiment of the present invention; and

FIG. 5 is a sectional view of the polishing composition in the second embodiment of the present invention.

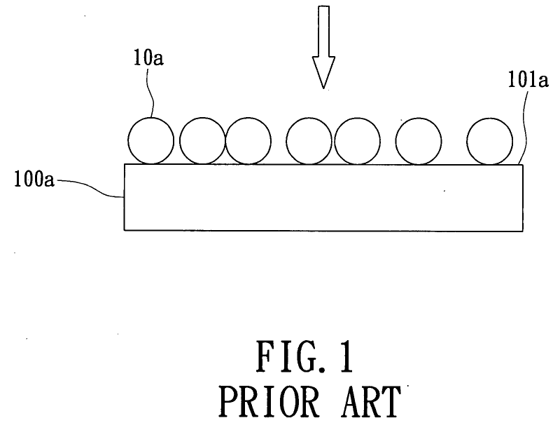

### DETAILED DESCRIPTION OF THE PREFERRED EMBODIMENTS

Now, the present invention will be described more specifically with reference to the following embodiments. It is to be noted that the following descriptions of preferred embodiments of the present invention are presented herein for purpose of illustration and description only; it is not intended to be exhaustive or to be limited to the precise form disclosed.

A method of making a polishing composition for polishing a substrate is provided in the present invention, comprising the following steps.

(a) At least a single type of a plurality of abrasive particles, a liquid organic resin, and an initiator are mixed and stirred to form a slurry, in which the abrasive particles may be a single type particle or mixed with each other into a mixed particles, the size of which ranges from 0.5 μm to 100.0 μm, and the percentage of the weight of the particles occupies 40-85% of the weight of the slurry.

The abrasive particles are made from one of ceric oxide, aluminum oxide, diamond, silicon carbide, zirconia, silicon dioxide, barium carbonate, titanium oxide, and silicon.

The percentage of the weight of the organic resin occupies 15˜60% of that of the slurry, and the organic resin is made from one of acrylic resin, polyketone resin, unsaturated mylar, organosilicon resin, and epoxy resin.

The initiator is made from one of benzoyl peroxide (BPO), tert-butyl peroxybenzoate (TBPB), cobalt dichloride (COCl₂), and hydrogen peroxide (H₂O₂).

(b) Via stirring, grinding, or milling, the slurry is homogenized to scatter the lumps formed by the organic resin in the slurry and furthermore disperse the abrasive particles in the slurry.

(c) The slurry is poured into a mold in a predefined shape.

(d) Via heating, the abrasive particles bond with the organic resin, and thus the slurry is formed into the polishing composition in the corresponding predefined shape and the abrasive particles are thereby made to evenly disperse through out the polishing composition.

(e) The polishing composition is processed and cut, and thus the surface of polishing composition is formed into a required abrasive surface, wherein the form the required abrasive surface corresponds to that of the substrate.

In step (a) of mixing the abrasive particles, the organic resin, and the initiator, the following compositions or a group of compositions as follows may also be mixed to improve the property of the slurry for satisfying a user's various requirements, such as easiness of slurry preservation and enhancement of rigidity.
1. A solvent may be mixed to change the shape of slurry.
2. An inhibitor, such as hydroquinone (HQ), may be mixed to easily preserve the slurry.
3. A plasticizer may be mixed, being made from one of dibutyl phthalate (DBP), dioctyl phthalate (DOP), and benzyl butyl phthalate (BBP).
4. A hardener may be mixed, being made from amide, cynate, and aldehyde.

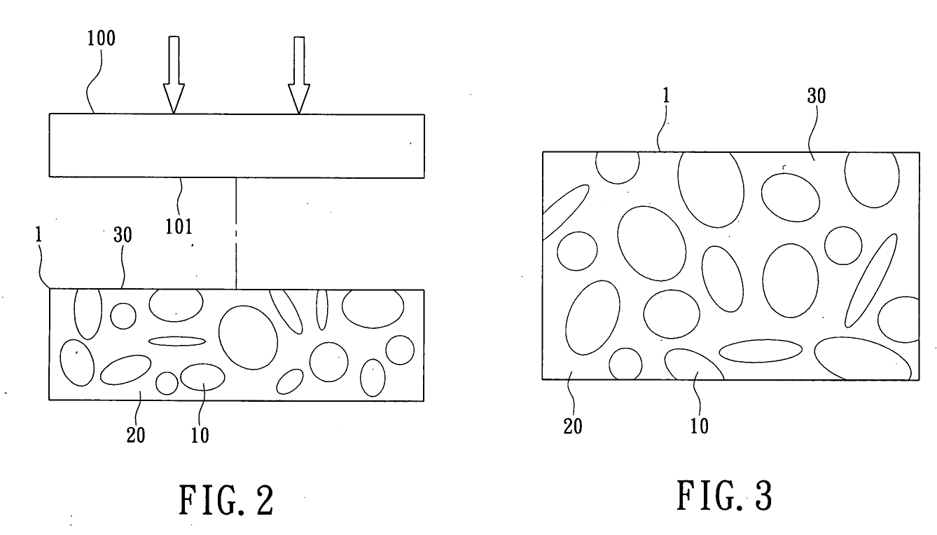

With reference to FIGS. 2 and 3 illustrating a first embodiment of a polishing composition 1 formed by the above mentioned method, wherein the polishing composition 1 is used to abrade a substrate 100 that may be a piece of glass, an optical lens, a wafer, a quartz, a sapphire, a porcelain, a ceramic, a solar panel, a iron part, or a building material. In the first embodiment, the substrate 100 is glass.

The polishing composition 1 comprises the plurality of abrasive particles 10, at least a single type of organic resin 20, and the initiator (not shown), wherein the abrasive particles 10 may be a single type particle or mixed particles and the organic resins 20 may also be a single type resin or mixed resins. With the organic resins 20, the abrasive particles 10 may bond into unity and evenly disperse through out the polishing composition 1.

The polishing composition 1 is in the corresponding predefined shape. In the embodiment, the polishing composition 1 is cubic, the shape of which is not limited in the present invention. A top of the polishing composition 1 is formed with an abrasive surface 30 contacting the substrate 100, wherein the abrasive surface 30 is a plane in the shape of a square and the abrasive surface 30 is via general technology of cutting, thereby the polishing composition 1 according to the present invention is formed.

When the polishing composition 1 is used to polish the substrate 100, the polishing composition 1 is held immovable and a pressure is applied to the polishing composition 1 from the substrate 100 (i.e. optical lends), in the direction of arrows shown in FIG. 2. Utilizing the abrasive surface 30 of the polishing composition 1, the surface 101 of substrate 100 is polished.

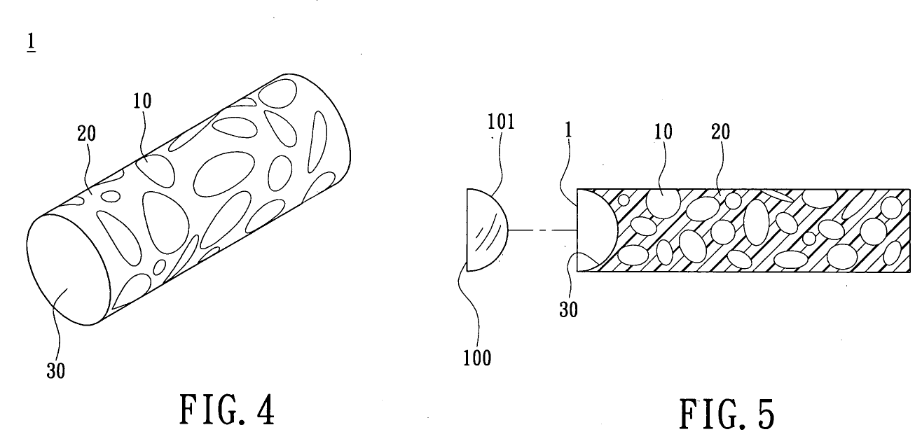

Refer to FIGS. 4 and 5 illustrating a second embodiment of the polishing composition 1 according to the present invention, the different between the first embodiment this second embodiment is described as follows.

The polishing composition 1 is in the shape of a round bar, furthermore the substrate 100 is the optical lens and is provided with a surface 101 in the shape of a protruding arc. One side of the polishing composition 1 is cut and then formed into the abrasive surface 30 in the shape corresponding to the surface 101 of substrate 100. In the second embodiment, the abrasive surface 30 is formed into a depressed surface in the shape of arc.

When polishing the substrate 100 (i.e. optical lens), the polishing composition 1 is held securely and then axially turns over and over around the substrate 100, and the abrasive surface 30 of polishing composition 1 is used to contact and polish the surface 101 of the substrate 100.

Certainly, the shape of polishing composition 1 is not limited and depends on the user's request. The abrasive surface 30 may also be the arc-shape protruding surface or in the other form corresponding to the substrate 100 for the polishing process.

Indeed, the polishing composition according to the present invention has the following features and functions.
1. The organic resin can be chosen and changed to make the polishing composition flexible so that the abrasive particles which has hardness much higher than that of substrate may still be applied due to the added flexibility of the present invention, and thus the abrasive particles does not have to be limited to applying just one-size particles for polishing. In the present invention, various abrasive particles may be combined with each other to enhance their capability of cutting and prevent scratches from occurring.
2. The size of abrasive particle has been compressed to a smaller size, and thus the effect of polishing may be achieved as long as the abrasive particles disperse evenly in the polishing composition and closely pile up; thus, the limit of the size of abrasive particle may be lowered.
3. The polishing composition according to the present invention is solid and contains the abrasive particles that have weight which occupies more than 40% of total overall weight (i.e. abrasive particles weight dived by polishing composition weight is over 40%), and the area where the abrasive particles contact the substrate is thus larger so that the time of polishing may be significantly shortened and the yield may increase.
4. During polishing, the abrasive surface of the polishing composition according to the present invention is used to cut (smooth) the surface of the substrate, during polishing, only water, which serves as lubricant is needed to be added, but extra abrasive particles are not required so that the particles mat be effectively used, which will prevent=large amount of abrasive particles from being wasted and the environment from being polluted.

While the present invention has been described in terms of what is presently considered to be the most practical and preferred embodiments, it is to be understood that the present invention-needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A polishing composition for polishing a substrate, being in a predefined shape and comprising at least a single type of a plurality of abrasive particles, at least a single type of organic resin bonding with the abrasive particles into integral whole, and an initiator, furthermore the abrasive particles evenly disperse through out the polishing composition;
the abrasive particles being made from one of ceric oxide, aluminum oxide, diamond, silicon carbide, zirconia, silicon dioxide, barium carbonate, titanium oxide, and silicon, and the organic resin being made from one of acrylic resin, polyketone resin, unsaturated mylar, organosilicon resin, and epoxy resin.

2. The polishing composition according to claim 1, wherein the polishing composition is formed with an abrasive surface.

3. The polishing composition according to claim 1, wherein the size of the abrasive particles ranges from 0.5 μm to 100.0 μm.

4. A method of making a polishing composition for polishing a substrate, comprising the following steps of:
mixing and stirring at least a single type of a plurality of abrasive particles, at least a single type of liquid organic resin, and an initiator into a slurry;
making the abrasive particles from one of ceric oxide, aluminum oxide, diamond, silicon carbide, zirconia, silicon dioxide, barium carbonate, titanium oxide, and silicon, and the organic resin from one of acrylic resin, polyketone resin, unsaturated mylar, organosilicon resin, and epoxy resin;
homogenizing the slurry so as to make the abrasive particles evenly disperse in the slurry;
pouring the slurry into a mold with a predefined shape; and
forming the slurry into the polishing composition with the corresponding predefined shape.

5. The method of making the polishing composition according to claim 4, wherein after the step of forming the slurry into the polishing composition with the corresponding predefined shape, the method further comprises a step of processing and cutting the polishing composition to form the polishing composition with an abrasive surface.

6. The method of making the polishing composition according to claim 4, wherein the size of the abrasive particles ranges from 0.5 μm to 100.0 μm.

7. The method of making the polishing composition according to claim 4, wherein the weight of the abrasive particles occupies 40˜85% of the weight of the slurry.

8. The method of making the polishing composition according to claim 4, wherein the weight of the organic resin occupies 15˜60% of the weight of the slurry.

9. The method of making the polishing composition according to claim 4, wherein the slurry is formed via heating at the step of forming the slurry into the polishing composition in the corresponding predefined shape.

10. The method of making the polishing composition according to claim 4, wherein a solvent is further mixed at the step of mixing the abrasive particles, the organic resin, and the initiator.

11. The method of making the polishing composition according to claim 4, wherein an inhibitor, hydroquinone (HQ), is further mixed at the step of mixing the abrasive particles, the organic resin, and the initiator.

12. The method of making the polishing composition according to claim 4, wherein a plasticizer is further mixed at the step of mixing the abrasive particles, the organic resin, and the initiator, and is made from one of dibutyl phthalate (DBP), dioctyl phthalate (DOP), and benzyl butyl phthalate (BBP).

13. The method of making the polishing composition according to claim 4, wherein a hardener is further mixed at the step of mixing the abrasive particles, the organic resin, and the initiator, and is made from amide, cynate, and aldehyde.

14. The method of making the polishing composition according to claim 4, wherein via stirring, grinding, or milling, the slurry is homogenized at the step of homogenizing the slurry.
